(19) United States
(12) Patent Application Publication
(10) Pub. No.: US 2023/0184294 A1
(43) Pub. Date: Jun. 15, 2023

(54) SENSOR COMPONENT, BEARING HAVING SUCH A SENSOR COMPONENT, AND CONNECTION OF A FIRST CHASSIS COMPONENT HAVING SUCH A BEARING TO A FURTHER CHASSIS COMPONENT

(71) Applicant: ZF Friedrichshafen AG, Friedrichshafen (DE)

(72) Inventors: Tim Holthaus, Sendenhorst (DE); Josef Holtheide, Neuenkirchen (DE); Julian Stratmann, Bad Essen (DE); Hermann Frye, Osnabrueck (DE); Florian Bäumer, Westerkappeln (DE); Laurence Schippmann, Krusa (DE)

(73) Assignee: ZF Friedrichshafen AG, Friedrichshafen (DE)

(21) Appl. No.: 17/997,035

(22) PCT Filed: Apr. 20, 2021
(86) PCT No.: PCT/EP2021/060203

§ 371 Date: Oct. 25, 2022

(30) Foreign Application Priority Data
May 18, 2020 (DE) 10 2020 206 201.3

(51) Int. Cl. F16C 41/00; F16C 33/12

(52) U.S. Cl. CPC F16C 41/00; F16C 33/122; G01D 5/145

(57) ABSTRACT

Sensor component with a magnetic field sensor (2) for co-operating with at least one magnet (24, 26) and with a component structure (3), where the magnetic field sensor (2) is arranged on and/or in the component structure (3). In order to reduce the manufacturing cost and/or the assembly effort and/or to be able in a simple manner to position the magnetic field sensor (2) as close as possible to the at least one magnet (24, 26), the sensor component (1) is characterized in that the component structure (3) is in the form of a screw for producing a screw connection (15).

### RELATED APPLICATIONS

This application claims the benefit under 35 U.S.C. § 371 as a U.S. National Phase Application of international application no. PCT/EP2021/060203, filed on 20 Apr. 2021, which claims benefit of German Patent Application no. 10 2020 206 201.3, filed 18 May 2020, the contents of which are hereby incorporated herein by reference in their entireties.

### FIELD OF THE DISCLOSURE

The invention relates to a sensor component with a magnetic field sensor for co-operating with at least one magnet and with a component structure such that the magnetic field sensor is arranged on and/or in the component structure. In addition, the invention relates to a bearing for a first chassis component of a vehicle, with an internal sleeve and an external sleeve, wherein an elastomer layer is arranged between the internal sleeve and the external sleeve, and with at least one magnet that co-operates with a sensor component of the type mentioned above. Finally, the invention relates to a connection of a first chassis component to a further chassis component, wherein the first chassis component comprises a bearing of the type mentioned above.

### BACKGROUND

From DE 102 55 234 A1 a bearing with an internal sleeve and an external sleeve is known, wherein an elastomer layer is arranged between the internal sleeve and the external sleeve. In this case, a number of magnets that form a pole ring surround the elastomer layer in a ring. Embedded in the internal sleeve there are two sensors such that the outer sides of those sensors round off an outer contour of the internal sleeve. Such sensors are usually fixed by a material—merging connection, such as by means of an adhesive, into a recess in the outer circumference of the internal sleeve that corresponds in shape to the sensor.

Furthermore, from DE 10 2017 208 410 B3 the use of a sensor component is known, which is held in a recess of a joint housing. In this case, at least to judge from the figures, the sensor component is plug-shaped.

### SUMMARY

The purpose of the present invention is to develop further a sensor component, a bearing and/or a connection of the type mentioned at the start, in such manner that the manufacturing costs and/or the assembly effort are reduced and/or the magnetic field sensor can in a simple way be positioned as close as possible to the at least one magnet. In particular, an alternative embodiment should be provided.

The objective upon which the invention is based, is achieved with a sensor component, a bearing, and/or a connection, in accordance with the present disclosure. Preferred further developments of the invention are to be found in the claims and in the detailed description.

The sensor component comprises a magnetic field sensor designed to co-operate with at least one magnet. For example, the magnetic field sensor is in the form of a Hall sensor. Furthermore, the sensor component comprises a component structure. Preferably, by virtue of the component structure a design and/or contour or outer contour of the sensor component is determined or fixed. In particular the component structure is in the form of a sensor housing of the sensor component. The magnetic field sensor is arranged on and/or in the component structure. In particular, the magnetic field sensor is held, attached, or fixed on and/or in the component structure. Moreover, the component structure is in the form of a screw for producing a screw connection.

In this way, it is advantageous that by virtue of the design of the component structure as a screw, the magnetic field sensor can be arranged sufficiently close to the at least one magnet in a simple way. Preferably, the sensor component has a dual function. Thus, by means of the sensor component, on the one hand the magnetic field sensor is provided for co-operating with the at least one magnet. On the other hand, the sensor component can be used like an ordinary screw for making a screw connection. For example, if a screw is needed for fastening a bearing to a chassis component, then instead of an ordinary screw a sensor component according to the invention can now be used. In that way an additional component for arranging the magnetic field sensor can be dispensed with.

Preferably, the component structure has a screw head and a screw-in bolt. In particular, the screw head and the screw-in bolt are connected to one another to form an integral component structure. In other words, the screw head and the screw-in bolt can merge integrally into one another. In particular, the outer diameter of the screw head is larger than that of the screw-in bolt. The screw head can have a stop or a stop-collar. By means of the said stop or stop-collar the screwing-in of the component structure can be limited. The magnetic field sensor is arranged and/or embedded inside the screw head or inside the screw-in bolt. In particular, the embedding of the magnetic field sensor inside the screw head or inside the screw-in bolt encapsulates the sensor completely relative to the surroundings. In that way any undesired contamination or damage of the magnetic field sensor, for example by dirt particles or moisture, can be avoided.

In particular, the screw-in bolt or at least a section of the screw-in bolt has an external thread. The external thread enables the sensor component or the component structure to be screwed into a correspondingly designed internal thread. Preferably, the screw-in bolt has a first cylindrical section and a second cylindrical section. The first cylindrical section can have no external thread, while the second cylindrical section has the external thread. Preferably, the first cylindrical section is arranged between the screw head and the second cylindrical section. In other words, the second cylindrical section is arranged at an end of the first cylindrical section remote from the screw head. In particular, the magnetic field sensor is in and/or on the first cylindrical section.

In a further embodiment the screw head comprises a data transmission line, which is connected on one side to the magnetic field sensor and on the other side extends out of the screw head for connection to an evaluation unit. In particular, the data transmission line runs radially outward from a central longitudinal axis of the sensor component or component structure. Alternatively, it is conceivable for the screw-in bolt to comprise the data transmission line, which on one side is connected to the magnetic field sensor and on the other side extends out of the screw-in bolt for connection to the evaluation unit. In particular, the data transmission line emerges out of the screw-in bolt at its end remote from the screw head.

According to a further development, the screw head has a screw head cap, or a screw head cap is associated with the screw head and is or can be connected to the screw head. The screw head cap can be attached to the screw head detachably and/or by plug-in means. The screw head cap can comprise the data transmission line, which is connected on one side to the magnetic field senor and on the other side extends out of the screw head and/or the screw head cap for connection to the evaluation unit. The screw head cap can be made as a separate component. In that way the component structure, together with the magnetic field sensor, can first be screwed into place. When the screw connection has been made, to complete the sensor component the screw head cap can be positioned on the screw head. This can be done, for example, with a snap-on or latch-type connection. Moreover, in this way the data transmission line can be connected to the magnetic field sensor at the same time.

Particularly advantageous is a bearing for a first chassis component of a vehicle, having an inner sleeve and an outer sleeve and with an elastomer layer between the said inner and outer sleeves, and with at least one magnet that co-operates with a sensor component according to the invention. In this case the component structure of the sensor component, in the form of a screw, extends through a through-going opening in the internal sleeve for the purpose of connection to a further chassis component.

In particular, the vehicle is a motor vehicle. The chassis component can be a control arm, a control arm component, a wheel carrier, a track rod, an axle support or the like. The bearing can be, or can be arranged, in the first chassis component preferably in a bearing holder of the chassis component. Preferably, the external sleeve is fixed into the bearing holder of the first chassis component, in particular, pressed into it. In particular, the sensor component and/or the bearing is used or arranged in a chassis of a vehicle. Bearings in the chassis can serve to connect chassis components articulated to one another or to the vehicle body or to an axle support attached thereto.

The internal sleeve and/or the external sleeve can at least essentially be of hollow-cylindrical form. In particular the bearing is in the form of a rubber bearing. Such a rubber bearing can for example be used for the articulated or rotatable fastening of the first chassis component to a further chassis component, a vehicle superstructure, a vehicle body or an axle support. In particular the elastomer layer consists of an elastomer material or a rubber material. The elastomer layer can be ring-like or annular. Preferably, a space between the external sleeve and the internal sleeve is completely filled by the elastomer material of the elastomer layer.

The magnet, the magnetic field sensor, and the sensor component can be part of a sensor device. In particular, the sensor device is in the form of an angle measurement device. The angle measurement device can also comprise an evaluation unit which evaluates the data from the magnetic field sensor. In particular, by means of the angle measurement device an angle and/or a rotation of the internal sleeve relative to the external sleeve and/or relative to the first chassis component can be detected and/or determined. In that way, height level information about the chassis and/or the vehicle body relative to a roadway can be determined.

According to a further development, the component structure comprises a screw head and a screw-in bolt, wherein the magnetic field sensor is arranged inside the screw-in bolt and inside the through-going opening of the internal sleeve. In that way the magnetic field sensor can be arranged within the bearing in a simple manner. This makes it possible on the one hand to position the magnetic field sensor as close as possible to the at least one magnet. On the other hand, owing to its arrangement within the through-going opening of the internal sleeve the magnetic field sensor is additionally protected against environmental influences such as contamination or humidity.

In a further embodiment an outside of the screw-in bolt of the component structure within the through-going opening of the internal sleeve is arranged so that it does not contact an inside of the through-going opening. In particular, a free gap or air-gap is formed between the outside of the screw-in bolt and the inside of the through-going opening. In that way an undesired transfer of loads and/or deformations by way of the internal sleeve to the screw-in bolt and/or the magnetic field sensor can be avoided or at least reduced. In particular, a section of the screw-in bolt with an external thread is or can be screwed into an internal thread of the further chassis component that corresponds to the said external thread.

The at least one magnet can be arranged in or on the elastomer layer, the external sleeve, and/or the first chassis component. For example, a single magnet can be arranged on the external sleeve of the bearing. Alternatively, a single magnet or a plurality of magnets can be arranged inside the elastomer layer.

Furthermore, particularly advantageous is a connection between a first chassis component and a further chassis component, in which the first chassis component comprises a bearing according to the invention. In particular, the connection is in the form of a screw connection. In this, the first chassis component is connected to the further chassis component by means of the component structure of the sensor component in the form of the screw. By virtue of the articulated and/or rotatable bearing the first chassis component can be connected to the further chassis component in an articulated and/or rotatable manner. In this case, by virtue of the component structure in the form of a screw the sensor component advantageously has a dual function. On the one hand the sensor component performs a customary screw function for producing a screw connection between the first chassis component and the further chassis component. On the other hand, by virtue of the sensor component the magnetic field sensor is arranged on or in the bearing sufficiently near to the at least one magnet and is at the same time protected against environmental influences.

Preferably the bearing and/or the connection is developed further in accordance with the designs explained herein in relation to the sensor component according to the invention. Furthermore, the sensor component described herein can be developed further in accordance with the designs explained in relation to the bearing and/or the connection.

### BRIEF DESCRIPTION OF THE DRAWINGS

Below, the invention is explained in greater detail with reference to the figures. In these, the same indexes denote the same, similar or functionally equivalent components or elements. The figures show:

FIG. 1: A sectioned side view of a sensor component according to the invention,

FIG. 2: A sectioned side view of the sensor component according to the invention shown in FIG. 1, in a first bearing according to the invention and to produce a connection according to the invention, and

FIG. 3: A sectioned side view of the sensor component according to the invention shown in FIG. 1, in a further bearing according to the invention and to produce a connection according to the invention.

### DETAILED DESCRIPTION

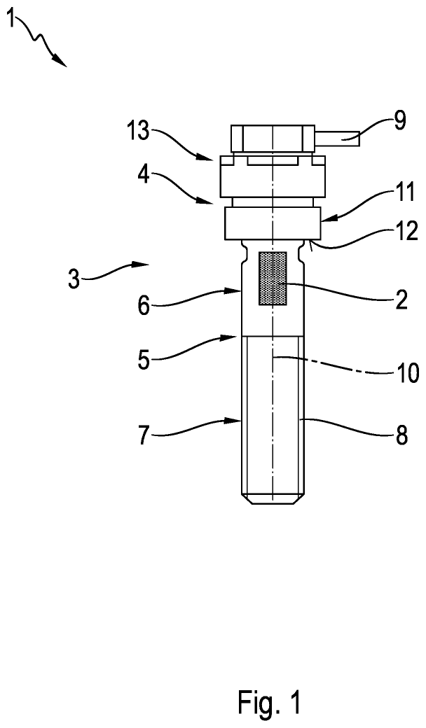

FIG. 1 shows a sectioned side view of a sensor component 1 according to the invention. The sensor component 1 comprises a magnetic field sensor 2. Moreover, the sensor component 1 has a component structure 3. In this example embodiment the magnetic field sensor 2 is arranged inside the component structure 3. The design of the sensor component 1 is established by virtue of the component structure 3. The component structure 3 forms a kind of sensor housing of the sensor component 1. The component structure 3 is in the form of a screw for producing a screw connection.

The component structure 3 comprises a screw head 4 and a screw-in bolt 5. The screw-in bolt 5 is made integrally with the screw head 4. In this example embodiment the magnetic field sensor 2 is arranged inside the screw-in bolt 5. As an example, here the magnetic field sensor 2 is embedded in the screw-in bolt 5, so that the magnetic field sensor 2 is encapsulated against external environmental influences.

In this example embodiment, the screw-in bolt 5 has a first cylindrical section 6 and a second cylindrical section 7. The first cylindrical section 6 is arranged between the screw head 4 and the second cylindrical section 7. In other words, the screw head 4 and the second cylindrical section 7 are arranged at two opposite ends of the first cylindrical section 6. The second cylindrical section 7 has an external thread 8. In this example embodiment, the first cylindrical section 6 has no external thread. In this case the magnetic field sensor 2 is arranged inside the first cylindrical section 6.

The screw head 4 has a data transmission line 9. The data transmission line 9 is connected on the one hand to the magnetic field sensor 2 and on the other hand it extends outward from the screw head 4 in order to be connected to an evaluation unit (not illustrated further here). In this example embodiment the data transmission line 9 extends from the screw head 4, radially outward relative to a central longitudinal axis 10 of the sensor component 1 or the component structure 3.

The screw head 4 has a stop 11. In this example embodiment the stop 11 is in the form of a stop-collar. The screw head 4 and the stop 11 have larger outer diameters that the screw-in bolt 5. The stop 11 is located immediately adjacent to the screw-in bolt 5. In the area of the stop 11 the screw head 4 merges into the screw-in bolt 5.

The stop 11 has a stop surface 12. The stop surface 12 faces toward the screw-in bolt 5. Furthermore, the stop surface 12 is directed perpendicularly to the central longitudinal axis 10. By means of the stop 11 and the stop surface 12, the screw-in depth of the sensor component 1 into an internal thread—not illustrated in greater detail here—that corresponds with the external thread 8 is limited.

In this example embodiment the screw head 4 has a screw head cap 13, or a screw head cap 13 is arranged on the screw head 4. The screw head cap 13 comprises the data transmission line 9. Moreover, the screw head cap 13 is connected detachably to the screw head 4 by means of a snap-on and/or latch-type connection. Thus, the component structure 3 can first be screwed into a correspondingly designed internal thread by virtue of the external thread 8. During this the screw head 4 is not yet covered by the screw head cap 13. Only when the process of screwing the component structure 3 in has been completed, can the screw head cap 13 be attached to the component structure 3 or the screw head 4. This reduces the risk of any undesired damage to the data transmission line 9 during the screwing-in process.

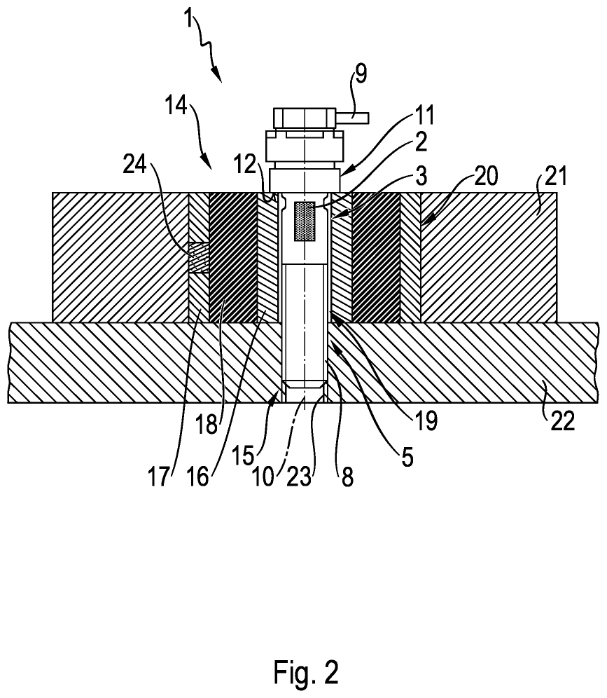

FIG. 2 shows a sectioned side view of the sensor component 1 according to FIG. 1 in a first bearing 14 according to the invention, and for forming a connection 15 according to the invention. In this case the connection 15 is a screw connection.

The bearing 14 comprises an internal sleeve 16 and an external sleeve 17. The internal sleeve 16 and the external sleeve 17 are in the form of hollow cylinders, and in this example embodiment they are made of metal. An elastomer layer 18 is arranged between the internal sleeve 16 and the external sleeve 17. The elastomer layer 18 is made of an elastomer material. In this example embodiment the elastomer layer 18 is made from a rubber material. The first bearing 14 is correspondingly in the form of a rubber bearing. In this, the elastomer layer 18 connects an inner side of the external sleeve 17 with an outer side of the internal sleeve 16.

The internal sleeve 16 has a through-going opening 19, which in this example embodiment is of hollow-cylindrical form. The component structure 3 of the sensor component 1 in the form of a screw extends through the through-going opening 19 of the internal sleeve 16.

The bearing 14 is arranged in or pressed into a bearing holder 20 of a first chassis component 21. By means of the component structure 3 of the sensor component 1 in the form of a screw, the first chassis component 21 and the bearing 14 are connected to a further chassis component 22. For that purpose, the external thread 8 of the screw-in bolt 5 is screwed into a correspondingly designed internal thread 23 of the said further chassis component 22.

In this case, the component structure 3 is screwed into the internal thread 23 until the stop 11 or stop surface 12 encounters an end side of the internal sleeve 16. In this example embodiment an outer side or outer circumference of the screw-in bolt 5 of the component structure 3 is arranged inside the through-going opening 19 out of contact with the inside of the through-going opening 19. The magnetic field sensor 2 is also arranged inside the through-going opening 19.

The bearing 14 comprises a magnet 24. In this example embodiment the magnet 24 is arranged in the external sleeve 17. Alternatively, the magnet 24 can be arranged on the first chassis component 21 or at least partially within the elastomer layer 16. The magnet 24 co-operates with the magnetic field sensor 2.

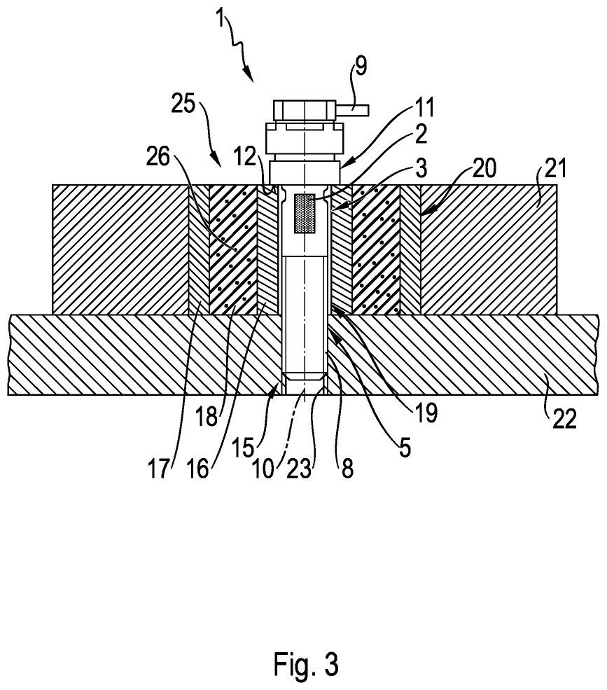

FIG. 3 shows a sectioned side view of the sensor component 1 of FIG. 1 in a further bearing 25 according to the invention and for forming the connection 15 according to the invention. The structure and functional mode of the further bearing 15 correspond in large measure to those of the first bearing 14 according to FIG. 2. Accordingly, to avoid repetition reference should also be made to the previous description.

However, instead of the single magnet 24, the bearing according to FIG. 3 comprises a plurality of magnets 26. For greater simplicity, not all the magnets 26 are indexed. The plurality of magnets 26 are arranged inside the elastomer layer 18. In this case the plurality of magnets 26 are completely embedded in the elastomer layer 18.

### INDEXES

1 Sensor component
2 Magnetic field sensor
3 Component structure
4 Screw head
5 Screw-in bolt
6 First cylindrical section
7 Second cylindrical section
8 External thread
9 Data transmission line
10 Central longitudinal axis
11 Stop
12 Stop surface
13 Screw head cap
14 First bearing
15 Connection
16 Internal sleeve
17 External sleeve
18 Elastomer layer
19 Through-going opening
20 Bearing holder
21 First chassis component
22 Further chassis component
23 Internal thread
24 Magnet
25 Further bearing
26 Magnet

1. A sensor component comprising a magnetic field sensor (2) configured to operate with at least one magnet (24, 26) and having a component structure (3), wherein the magnetic field sensor (2) is arranged on and/or in the component structure (3), and wherein the component structure (3) is in the form of a screw for forming a screw connection (15).

2. The sensor component according to claim 1, wherein the component structure (3) comprises a screw head (4) and a screw-in bolt (5), and the magnetic field sensor (2) is arranged and/or embedded inside the screw head (4) or the screw-in bolt (5).

3. The sensor component according to claim 2, wherein the screw-in bolt (5) or at least a section of the screw-in bolt (5) has an external thread (8).

4. The sensor component according to claim 2, wherein the screw head (4) comprises a data transmission line (9), which is connected on a first side to the magnetic field sensor (2) and a second side extends outward from the screw head (4) for connection to an evaluation unit.

5. The sensor component according to claim 2, wherein the screw head (4) has a screw head cap (13), the screw head cap (13) configured to be detached and/or plugged in, and the screw head cap (13) comprises a data transmission line (9), which is connected on a first side to the magnetic field sensor (2) and a second side extends outward from the screw head (4) and/or from the screw head cap (13) for connection to an evaluation unit.

6. A bearing for a first chassis component (21) of a vehicle, the bearing comprising:
an internal sleeve (16);
an external sleeve (17);
an elastomer layer (18) between the internal sleeve (16) and the external sleeve (17); and
at least one magnet (24, 26) configured to operate with a sensor component (1) according to claim 1, wherein the component structure (3) of the sensor component (1) is in the form of a screw and extends through the through-going opening (19) of the internal sleeve (16) in order to form a connection to a further chassis component (22).

7. The bearing according to claim 6, wherein the component structure (3) comprises a screw head (4) and a screw-in bolt (5), and the magnetic field sensor (2) is arranged inside the screw-in bolt (5) and inside the through-going opening (19) of the internal sleeve (16).

8. The bearing according to claim 6, wherein an outside of a screw-in bolt (5) of the component structure (3) is arranged inside the through-going opening (19) of the internal sleeve (16) making no contact with an inside of the through-going opening (19).

9. The bearing according to claim 6, wherein the at least one magnet (24, 26) is arranged in or on the elastomer layer (18) of the external sleeve (17) and/or of the first chassis component (21).

10. A connection of a first chassis component (21) with a further chassis component (22), wherein the first chassis component (21) comprises a bearing) (14, 25) according to claim 6, and the first chassis component (21) is connected to the further chassis component (22) by means of the component structure (3) of the sensor component (1).

11. The connection according to claim 10, wherein the component structure (3) comprises a screw head (4) and a screw-in bolt (5), and the magnetic field sensor (2) is arranged inside the screw-in bolt (5) and inside the through-going opening (19) of the internal sleeve (16).

12. The connection according to claim 11, wherein an outside of the screw-in bolt (5) of the component structure (3) is arranged inside the through-going opening (19) of the internal sleeve (16) without making contact with an inside of the through-going opening (19).

13. The connection according to claim 12, wherein the at least one magnet (24, 26) is arranged in or on the elastomer layer (18) of the external sleeve (17) and/or of the first chassis component (21).

14. The connection according to claim 13, wherein a section of the screw-in bolt (5) having an external thread (8) is screwed into an internal thread (23) of the said further chassis component (22), wherein the internal thread (23) corresponds with the external tread (8).
